(19) United States
(12) Patent Application Publication
(10) Pub. No.: US 2016/0251125 A1
(43) Pub. Date: Sep. 1, 2016

(54) DISPENSING VALVE AND USE THEREOF

(71) Applicant: ASEPT INTERNATIONAL AB, Lund (SE)

(72) Inventors: Sten Drennow, Lund (SE); Stefan Cedergren, Bunkeflostrand (SE); Rickard Truedsson, Gärds Köpinge (SE)

(21) Appl. No.: 15/032,683

(22) PCT Filed: Oct. 24, 2014
(86) PCT No.: PCT/IB2014/065590

§ 371 Date: Apr. 28, 2016

(30) Foreign Application Priority Data
Nov. 1, 2013 (SE) 1300679-6
Jul. 2, 2014 (SE) 1400335-4

(51) Int. Cl. B65D 47/20; B05B 11/00; B67D 1/00; B65D 35/28

(52) U.S. Cl. CPC B65D 47/2031; B65D 35/28; B05B 11/007; B67D 1/0001; B67D 1/0082

(57) ABSTRACT

The present invention relates to a dispensing valve (1) adapted to allow dispensing of a product (2), preferably a food product, for example a beverage, from a container (3) which is preferably closed and has the ability to collapse when product is dispensed therefrom. The dispensing valve has an elastic membrane (7) with one or more valves (1a), which is/are closed when the membrane (7) assumes an initial position (A), and is/are open when the membrane assumes a stretched position (B) to allow dispensing of the product out of the container. When the membrane assumes its initial position (A), the valve (1a) or valves have contact with at least one support member (15), which prevents the valve (1a) or valves from opening, whereby air is prevented from passing through the valve (1a) or valves to product (2) present in said valve or valves.

### TECHNICAL FIELD

The present invention relates to a dispensing valve adapted to allow dispensing of a product, preferably a food product, for example a beverage, from a container which is preferably closed and preferably has the ability to collapse when product is dispensed therefrom. The dispensing valve has an elastic membrane with one or more valves, which is/are closed when the membrane assumes an initial position, and which is/are open when the membrane assumes a stretched position to allow dispensing of product from the container.

The invention also relates to use of said dispensing valve.

### BACKGROUND

Dispensing devices for dispensing food products from food containers are generally known, and an example of such devices is apparent from the document WO 2013064203 A1. A special type of dispensing valves of the type mentioned by way of introduction and with advantageous function is known from the document U.S. Pat. No. 5,213,236.

However, said type of dispensing valves cannot be used in connection with dispensing of product, preferably food, from preferably closed containers which air must not flow into through the dispensing valves, as this would cause impairment of the durability of the product.

### SUMMARY OF THE INVENTION

It is the object of the present invention to achieve, by simple means, that dispensing valves of said or similar type can be used in conjunction with dispensing devices for dispensing a product from closed containers without there being risk that air might flow into product present in the valves and in the container.

This object of the invention is achieved by means of at least one dispensing valve adapted to enable dispensing of a product from a container and use of such dispensing valve as defined in the appended independent claims. Preferred variants of the Invention are defined in the corresponding dependent claims.

The dispensing valve adapted for dispensing of product from closed containers in accordance with the independent claim makes it possible to simplify and ensure an efficient and airtight closing of the valve by eliminating air leakage in and through the valve as the valve physically reaches and is in contact with a support member after closing.

The invention defines a dispensing valve adapted to enable/allow dispensing of a product from a container. The product is preferably a food product. The food product is, for example, a beverage. Preferably, the container is closed. Preferably, the container has the ability to collapse when product is dispensed therefrom. The dispensing valve has an elastic membrane. The membrane comprises one or more valves. The valve/valves is/are closed when the membrane assumes an initial position A or C, and is/are open when the membrane assumes a stretched position B or D to allow dispensing of product from the container. The dispensing valve is characterized in that the valve or valves have contact with at least one support member when the membrane assumes its initial position A or C, such that the support member prevents the valve or valves from opening, thereby preventing air from passing through the valve or valves to product present in said valve or valves

According to one embodiment, the dispensing valve Is characterized in that the membrane has an annular outer part and an inner part connected thereto, allowing the same, by rolling movements, to move from its initial position A or C to its stretched position B or D, and vice versa.

According to another embodiment, the dispensing valve is characterized in that in its initial position A or C the membrane has a shape bulging in a direction inwards towards the support member.

According to still another embodiment, the dispensing valve is characterized in that the support member is designed at least partially as a tubular member with an end wall against which the membrane can abut, and that the tube member allows through-flow of product between the container and the dispensing valve.

According to yet an embodiment, the dispensing valve is characterized in that at least two valves are arranged separately on the membrane and each separately having contact with the support member when the membrane assumes its initial position C, and each separately being open when the membrane assumes its stretched position D.

According to a further embodiment, the dispensing valve is characterized in that in the initial positions F the valves have contact, each separately, with the support member, and are stretchable, each separately, to the stretched position G.

According to one embodiment, the dispensing device is characterized in that In a stretched position O, the membrane has a bulging shape, and that in this shape of the membrane the valves are inclined relative to one another. Thus, the valves can deliver/dish out product in divergent out-flow directions relative to one another when they are open.

According to another embodiment, the dispensing valve is characterized in that each valve separately has openable slits.

According to a further embodiment the dispensing valve is characterized in that each valve has an outer part which allows rolling function when the valve changes position between initial position F and its stretched position G, and vice versa.

According to another embodiment, the dispensing valve is characterized in that each valve has outer and inner parts, the outer part being thinner than the inner part.

According to still another embodiment, the dispensing valve is characterized in that the membrane and valves that are part thereof consist of the same silicone material.

According to yet a further embodiment the dispensing valve is characterized In that the membrane and valves that are part thereof have a wall thickness of essentially 0.2 mm.

According to one embodiment, the dispensing valve is characterized in that the membrane and valves that are part thereof consist of the same silicone material and have a wall thickness of essentially 0.2 mm.

According to yet an embodiment, the dispensing valves is characterized in that the valves are identical or essentially identical.

According to a further embodiment, the dispensing valve is characterized in that preferably the valves have circular shape.

According to still another embodiment, the dispensing valve is characterized in that the valves are identical or essentially identical and preferably have circular shape.

According to yet an embodiment, the dispensing valve is characterized in that in its initial position C, the membrane is essentially plane, and that the valves are directed towards the support member when the membrane assumes said initial position C.

The invention relates to use of a dispensing valve according to any of the above, characterized in that the dispensing valve is used in conjunction with a dispensing device comprising: a) a tube member of elastically resilient material, said tube member being connected or connectable, or vice versa, to a food container, such that food product present in the food container may flow from the food container into the tube member; b) a dispensing device for compressing the tube member to dispense food product therefrom to the dispensing valve; and c) a check valve between the food container and the tube member, which prevents food product from flowing from the tube member back to the food container.

Use of the dispensing valve according to one embodiment, characterized in that the dispensing valve is used in conjunction with said dispensing device, where the tube member and the food container can be coupled to one another by a coupling device provided with an outer, tubular coupling member and an inner coupling member arranged In the food container, and that the food container is openable by means of the outer, tubular coupling member when it is coupled to the inner coupling member.

Use of the dispensing valve according to another embodiment, characterized in that the dispensing valve is used in conjunction with said dispensing device, where the outer, tubular coupling member allows food product to flow there through from the food container to the tube member.

Use of a dispensing valve according to yet another embodiment, characterized in that the dispensing valve is used in conjunction with a container, which is a food container of airtight material, which can be opened when it is coupled together with the dispensing valve.

Use of a dispensing valve according to a further embodiment, characterized in that the dispensing valve is used in conjunction with a food container of the airtight plastic bag type.

### DESCRIPTION OF THE FIGURES

FIG. 1 shows a dispensing valve according to the invention, in section and in enlarged scale.

FIG. 2 shows a slit exhibiting part of the dispensing valve according to FIG. 1.

FIG. 3 shows the dispensing valve according to FIG. 1, arranged on a dispensing device.

FIG. 4 shows an exploded view of a dispensing device with an alternatively designed dispensing valve according to the invention.

FIG. 5 shows a section of a dispensing valve according to FIG. 4.

FIG. 6 shows the dispensing valve according to FIG. 5, from below and in a plane view.

### DESCRIPTION OF THE INVENTION

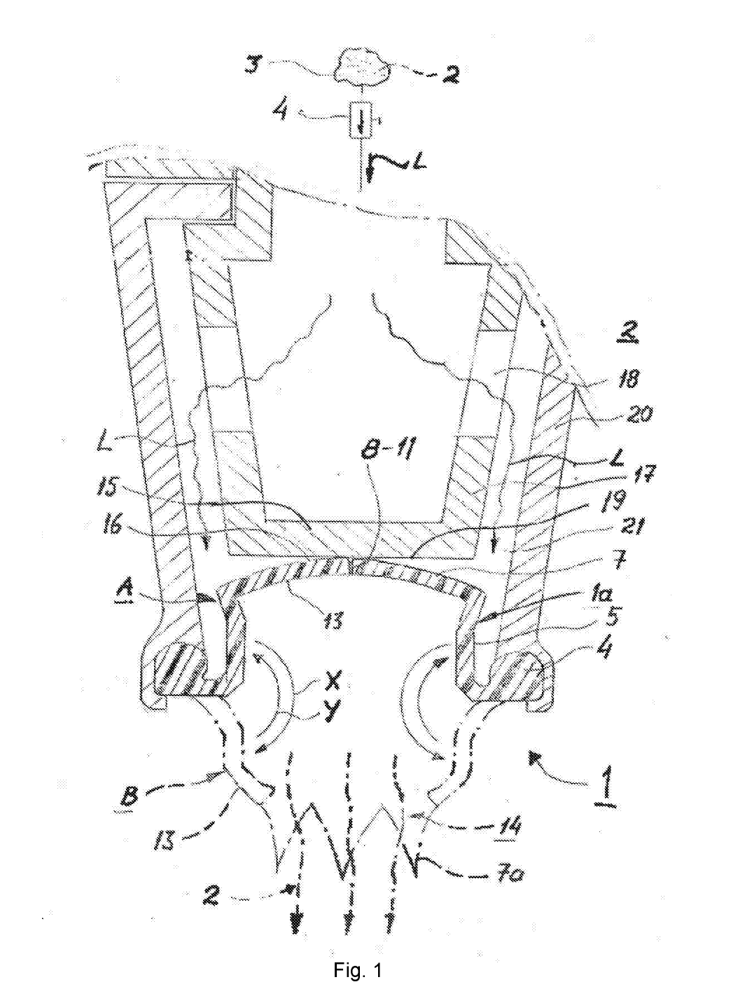

The valve 1, 1a shown in FIGS. 1-3 is adapted to allow dispensing of a product 2, preferably a food product, for example a beverage, from a container 3. Said container is preferably hermetically closed, and preferably has the ability to collapse when product 2 is dispensed therefrom. The dispensing of the food product 2 from the food container 3 may be done by means of some/any type of dispensing device 4, but alternatively dispensing may be done by squeezing the food container 3 by hand or hands or by auxiliary means (not shown).

The valve 1, 1a consists of or comprises elastically resilient and resilient/spring back material and has an annular outer part 5 and an inner part 6 connected thereto, which is designed as a membrane 7 that exhibits so-called rolling capacity/ability. Said membrane 7 may have a cap-like shape, and preferably it bulges in a direction towards the dispensing direction L of the food product 2.

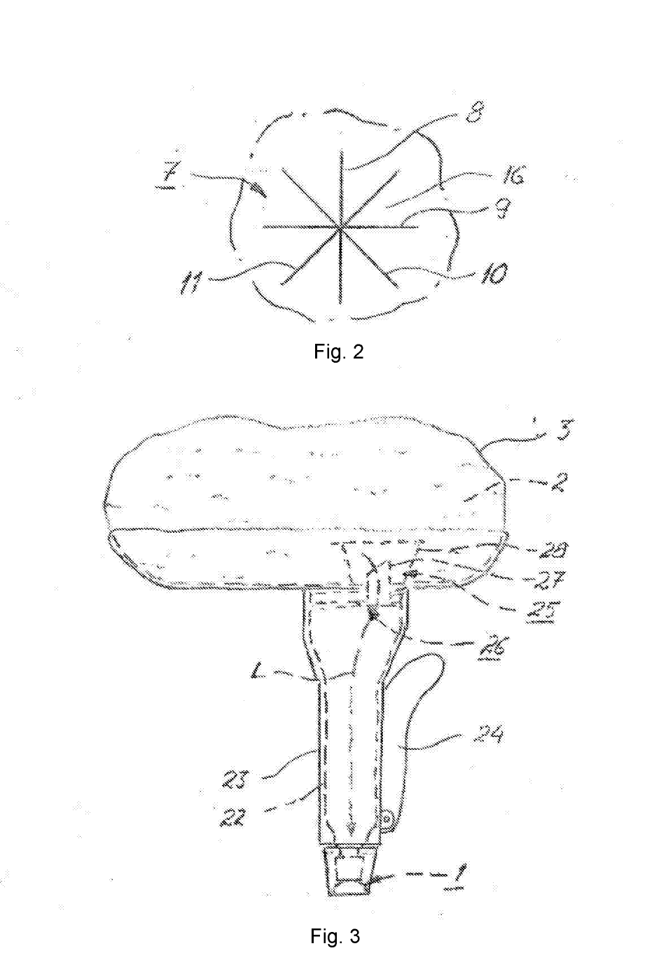

The roller membrane 7 has one or more slits, for example four slits 8, 9, 10, 11, preferably being arranged in central parts 16 thereof (see FIG. 2). When the roller membrane 7 assumes its initial position A, it keeps the slits 8-11 closed, and when it is imparted with a stretched position B, it allows the slits 8-11 to be open so as to form a dispensing opening 14 through which food product 2 can be dispensed. As shown in FIG. 1, the roller membrane 7 forms out-folded flaps 7a when the slits 8-11 are open.

The initial position A of the roller membrane 7 is shown by solid lines, and its stretched position B by dotted lines.

The roller membrane 7 can be imparted with a rolling movement in an opening direction X where it is pressure loaded by food product 2, which affects it when the food product 2 is pressed in the dispensing direction L. By said rolling movement in the opening direction X, the roller membrane 7 is pressed resiliently through the outer part 7, and when it has performed about half the opening movement it preferably performs a snap movement until it assumes its stretched position B. Thereby a rapid and distinct opening of the dispensing valve 1 is achieved.

When said pressure load on the roller membrane 7 has ceased, it performs a return rolling movement in a closing direction Y, whereby it snaps back through the outer part portion 5 to its initial position A, and when it has performed about half the return rolling movement in the closing direction Y, it preferably performs a snap-back movement, whereby a rapid and distinct closing of the dispensing valve 1 is achieved.

As further shown In FIG. 1, the position of the roller membrane 7 changes from a position in which it is preferably cap-shaped and protrudes relative to the outer part 5 in an upstream direction relative to the dispensing direction L of the food product 2 and is pressed in said dispensing direction L through the outer part 5 to a position in which it protrudes in a downstream direction relative to the outer part 5, and vice versa.

Said valve 1a has an advantageous function, but it is not usable for food containers 3 because the flaps 7a can fold inwards, and the slits 6-11 can open when it assumes initial form A. This would entail that air can get to the food product 2 and into food container 3 through the dispensing valve 1, which is unacceptable as this would impair or destroy the durability of the food product 2.

This problem is solved in a simple and effective manner by means of a support member 15 with which the roller membrane 7 has supporting contact when it assumes its initial position A. The support member 15 hereby prevents that the slits 8-11 may open when the roller membrane 7 assumes said initial position A, which entails that air cannot pass the valve 1a to food product 2 present in it when the roller membrane 7 assumes its initial position A. It may be advantageous that the roller membrane 7 abuts against the support member 15 under pressure, such that even the smallest opening of the slits 8-11 is prevented.

The support member 15 may be arranged and/or designed in various ways but nevertheless exhibit the desired function. An example of support member 15 is shown in the drawings, and in that embodiment it is designed as a tubular part 17 through which food product 2 may be supplied to the valve 1a. For this purpose, the tubular member 17 is open towards the food container 3, such that food product 2 can be fed into it, and it has lateral openings 18 through which food product 2 may be supplied to the valve 1a.

The support member 15 may have an end wall 19 with which the roller membrane 7 can cooperate in the manner stated. Furthermore, the support member 15 may be arranged within an outer tube member 20 which, together with the support member 15, forms a through-flow space 21 through which food product 2 can be fed to the valve 1a.

As mentioned, food product 2 can be dispensed by means of a dispensing device 4, and such a device may have a tube member 22 of elastically resilient/spring back material. Said tube member 22 may be arranged within a tube member 23 with a movable dispensing device 24. By a coupling device 25, said tube member 22 can be coupled to the food container 3, or vice versa. There may be a check valve 26, which prevents food product 2 present in the tube member 22 from flowing back therefrom to the food container 3.

Prior to dispensing food product 2, the dispensing device 24 is pressed in, whereby the tube member 22 is compressed and food product 2 is pressed out therefrom in direction L towards the valve 1a. When you let go of the dispensing device 24, the tube member 22 will resume its initial shape and hence return the dispensing device 24 to its initial position and at the same time draw in food product 2 from the food container 3 into it. After this, said dispensing procedure can be repeated.

The coupling device 25 may have an outer, tubular coupling member 27 and an inner coupling 28 arranged in the food container 3. Said coupling parts 27,26 can be coupled to one another by pressing a hole in the food container 3 with the outer coupling part 27 and then inserting it into the inner coupling part 28, and pressing/pushing the coupling parts 27, 28 together. In that the outer coupling part 27 is tubular, it is achieved that food product 2 can flow from the food container 3 through it to the tube member 22.

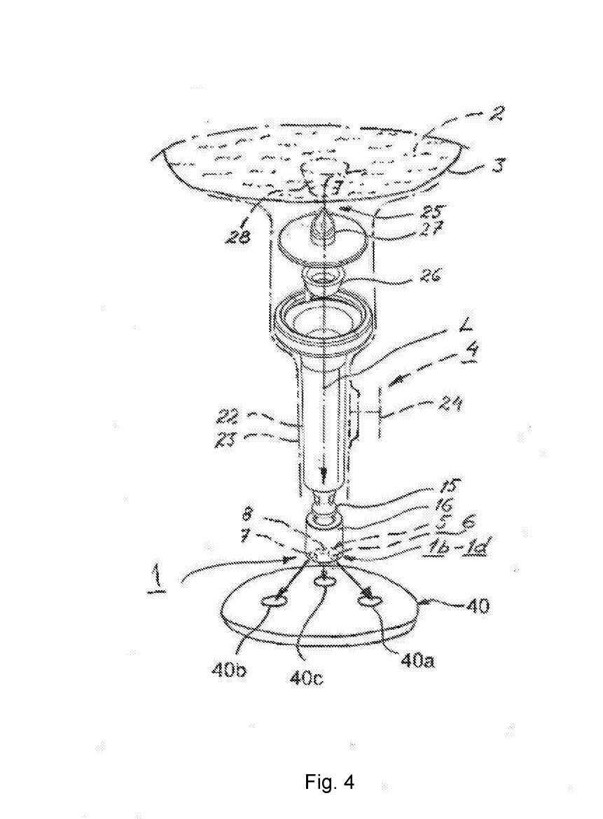

The dispensing valve 1 shown in FIGS. 4-6 has several valves, for example three valves 1b, 1c, 1d, instead of a single one, or only two such valves.

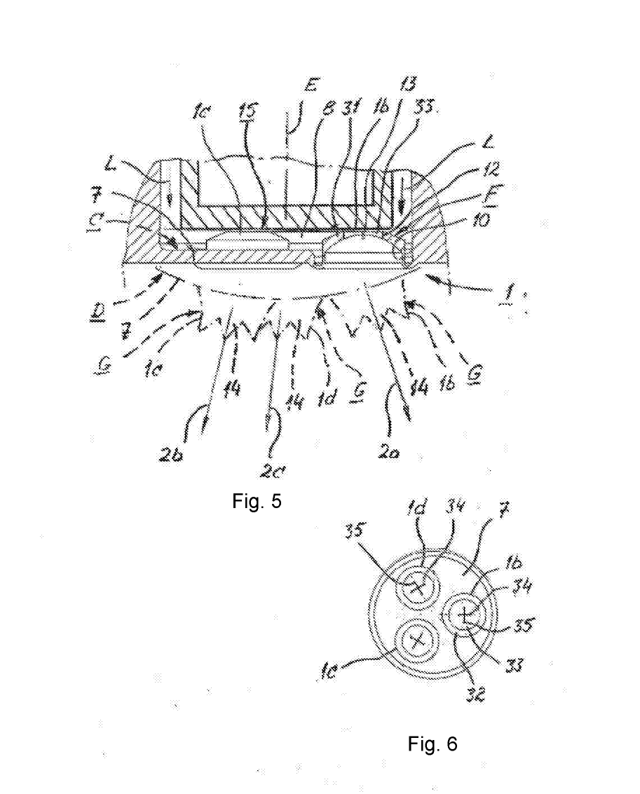

Also, in this embodiment the membrane 7 consists of elastically resilient and resilient/spring back material, and in a normal form it assumes an initial position C (shown by solid lines in FIG. 5). By the pressure impact from within in a product dispensing direction L, the membrane 7 can be made to assume a stretched position D (shown by dashed lines in FIG. 5) in which it bulges out in said dispensing direction L. When said pressure impact ceases, the membrane 7, by its spring back ability, automatically returns to its initial position C. Here, the membrane 7 may be plane or substantially plane, and in its stretched position D, it may bulge in the dispensing direction L and be substantially cap-shaped or dome-shaped.

In this embodiment, said membrane 7 has several, for example three, valves 1b-1d, each consisting of or comprising membrane parts 31 that are also elastically springy and resilient. Each valve 1b-1d has an annular and essentially circular outer part 32 and an inner part 33 with two or more intersecting slits 34,35 arranged within it, which slits pass through the membrane material. Each outer part 32 may act as roller membrane, that is, exhibit rolling capability, which allows the valve 1b-1d in question to change position from an initial position F (shown by solid lines in FIG. 5) to a stretched position G (shown by dashed lines in FIG. 5). This is accomplished by each valve 1b-1d being subjected to said pressure impact in said dispensing direction L, and when made to assume its stretched position G, the inner part 33 has been stretched and the slits 34, 35 opened to let out product 2. When said pressure impact ceases, the outer part 32 rolls back, entailing such that each valve 1b-1d automatically returns to its initial position F, and then the membrane parts 31 close the slits 34, 35 and hence the valve 1b-1d in question.

The membrane part 31 forming the outer part 32 of each valve 1b-1d may be thinner than the inner part 33. In addition, the membrane parts 31 may be thinner than the membrane 7 as such.

The valves 1b-1d are designed so as not to open until the membrane 7 has assumed its stretched position G, i.e. bulges out, which entails that they assume the positions in which they can deliver/dish out product in diverging out-flow directions 2a-2c relative to one another. Thus, in said positions the valves 1b-1d are directed obliquely outwards relative to an imaginary line E directed axially through the dispensing device, such that the three out-flow directions 2a, 2b, 2c diverge with respect to said line E and to one another. Hereby, product can be portioned out to, in this case, three different locations 40a, 40b, 40c on, for example, a dish 40.

In that the valves 1b-1d are preferably arranged symmetrically relative to one another and at one and the same distance from the line E, product can be dispensed in favorable directions.

In addition, the valves 1b-1d preferably have substantially identical design, whereby at each dispensing occasion each valve may portion out an equal amount of product from that valve or the other valves.

If after dispensing of product 2 negative pressure arises in the dispensing device 4 (and/or, where appropriate, in the container 3), the valves 1b-1d must not open when they assume their initial position F, because otherwise they would admit/let in air to not yet dispensed product 2. This Is prevented by means of said support member 15 with which the valves 1b-1d each have contact when they assume said initial positions F, and which thus prevents them from possibly opening.

The object of the invention is not limited to the above embodiments, but it may vary within the scope of the appended claims. The roller membrane 7 may have a different shape from that shown, and the food container 3 may be a plastic bag which is hermetically closed and which is not opened until food product 2 is to be dispensed therefrom. In addition, it should also be mentioned that the support member 15 may consist of more than one part. The container 3 may be a container for a product other than food, and the product 2 may thus be any liquid product for which durability is demanded. The container need not necessarily be able to collapse either, and it need not necessarily be airtight. Furthermore it should be mentioned that the membrane 7 may be of a different type than that mentioned, and that it may consist of silicone material. Furthermore, the membrane 7 may be designed integrally with and in the same material as a cylindrical part, which may be arranged replaceably on the dispensing device 4, for example on the support member 15. Optionally, the membrane 7 may be arranged as a gable-side on said part. The support member 15 may be arranged in a part of the dispensing device 4.

Finally, it should be mentioned that the product 2 may be a type of product different from those mentioned above, and preferably it is liquid.

1. A dispensing valve adapted to allow dispensing of a product, preferably a food product, for example a beverage, from a container which is preferably closed and preferably has the ability to collapse when product is dispensed therefrom, wherein the dispensing valve has an elastic membrane with one or more valves, which is/are closed when the membrane assumes an initial position, and openable when the membrane assumes a stretched position to allow dispensing of product from the container, the valve or valves having contact with at least one support member when the membrane assumes its initial position, such that the support member prevents the valve or valves from opening, whereby air is prevented from passing through the valve or valves to product present in said valve or valves, wherein
the support member is designed at least partially as a tubular member with an end wall against which the membrane can abut,
and in that the tubular member allows through-flow of product between the container and the dispensing valve.

2. A dispensing valve according to claim 1, wherein the membrane has an annular outer part and an inner part connected thereto, allowing it, by rolling movements, to move from its initial position to its stretched positron, and vice versa.

3. A dispensing valve according to claim 1, wherein, in its initial position, the membrane has a bulging shape in a direction inwards towards the support member.

4. A dispensing device according to claim 1, wherein the tubular member is open towards the food container, such that food product can be fed into it, and in that said tubular member has lateral openings through which food product may be supplied to the valve.

5. A dispensing device according to claim 1, wherein the support member is arranged within an outer tube member which, together with the support member, forms a through-flow space through which food product can be fed to the valve.

6. A dispensing valve according to claim 1, wherein at least two valves are arranged each separately on the membrane, and have contact each separately with the support member when the membrane assumes its initial position, and are openable each separately when the membrane assumes its stretched position.

7. A dispensing device according to claim 6, wherein, in the initial positions, the valves have contact each separately with the support member, and are stretchable each separately to stretched positions.

8. A dispensing device according to claim 6, wherein, in a stretched position, the membrane has a bulging shape, and that in this shape of the membrane, the valves are inclined relative to one another, such that the valves deliver product in divergent outflow directions relative to one another when they are open.

9. A dispensing device according claim 6, wherein each valve each separately has openable slits.

10. A dispensing device according to claim 6, wherein each valve has an outer part, which allows rolling function when the valve changes position between initial position and its stretched position, and vice versa.

11. A dispensing device according to claim 6, wherein each valve has outer and inner parts, the outer part being thinner than the inner part.

12. A dispensing device according to claim 5, wherein the membrane and valves that are past thereof consist of the same silicone material and have a wall thickness of essentially 0.2 mm.

13. A dispensing device according to claim 1, wherein the valves are identical or essentially identical and preferably have circular shape.

14. A dispensing device according to claim 5, wherein, in its initial position, the membrane is substantially plane, and that the valves are directed towards the support member when the membrane assumes said initial position.

15. Use of a dispensing valve according to claim 1, wherein the dispensing valve is used in conjunction with a dispensing device comprising;
a) a tube member of elastically spring back material, which tube member is connected or correctable, or vice versa, to a food container, such that food product present in the food container may flow from the food container into the tube member;
b) a dispensing device for compressing the tube member prior to dispensing food product therefrom to the dispensing valve, and
c) a check valve between the food container and the tube member, which prevents food product from flowing from the tube member back to the food container.

16. Use of the dispensing valve according to claim 15, wherein the dispensing valve is used in conjunction with said dispensing device, where the tube member and the food container can be coupled to one another by a coupling device with an outer, tubular coupling member and an inner coupling member arranged in the food container, and the food container is openable by means of the outer, tubular coupling member when it is coupled to the inner coupling member.

17. Use of the dispensing valve according to claim 16, wherein the dispensing valve is used in conjunction with said dispensing device, where the outer, tubular coupling member allows food product to flow through it from the food container to the tube member.

18. Use of a dispensing valve according to claim 1, wherein the dispensing valve is used in conjunction with a container, which is a food container of airtight material, which can be opened when it is coupled together with the dispensing valve.

19. Use of a dispensing valve according to claim 1, wherein the dispensing valve is used in conjunction with a food container of the airtight plastic bag type.
